(19) United States
(12) Patent Application Publication
(10) Pub. No.: US 2018/0120506 A1
(43) Pub. Date: May 3, 2018

(54) LASER TREATMENT DEVICE AND WORKSTATION COMPRISING SUCH A DEVICE

(71) Applicants: UNIVERSITE DE STRASBOURG, Strasbourg (FR); CENTRE NATIONAL DE LA RECHERCHE SCIENTIFIQUE, Paris (FR); INSTITUT NATIONAL DES SCIENCES APPLIQUEES, Strasbourg (FR); IREPA LASER, Illkirch-Graffenstaden (FR)

(72) Inventors: Sylvain LECLER, Strasbourg (FR); Andri ABDURROCHMAN, Illkirch-Graffenstaden (FR); Frederic MERMET, Ostwald (FR); Joel FONTAINE, Strasbourg (FR)

(21) Appl. No.: 15/573,044

(22) PCT Filed: May 13, 2016
(86) PCT No.: PCT/FR2016/051141

§ 371 Date: Nov. 9, 2017

(30) Foreign Application Priority Data
May 13, 2015 (FR) 1554317

(51) Int. Cl. G02B 6/26; G02B 27/09; G02B 6/028; G02B 6/255; G02B 6/36; B23K 26/06; B23K 26/21

(52) U.S. Cl. CPC G02B 6/262; G02B 27/0994; G02B 6/0288; B23K 2203/54; G02B 6/3624; B23K 26/0648; B23K 26/21; G02B 6/2552

(57) ABSTRACT

Disclosed is a laser treatment device and a workstation including such a device. The laser treatment device includes a laser head including an optical fiber terminating in a beam focusing end piece that is shaped from the free end portion of the fiber so as to form a single part therewith. The focusing end piece is rotationally symmetrical about an axis and has a shape defined externally by a substantially semi-elliptic convex curve of given dimensions, and the distance d between the tip of the focusing end piece and the working area, and the shape and positioning of the end piece are such that the laser head generates a slightly divergent, focused laser beam in the form of a photon jet, having a diameter at the working area of the order of magnitude of the wavelength.

The present invention relates to the field of treatment equipment, methods and installations using power laser radiation, for industrial, medical, artistic or other applications.

More specifically, the invention relates to a laser treatment device, a workstation comprising such a device and a treatment method using such a device.

The use of a laser beam to perform a treatment on a part, an item or a material is well known by those skilled in the art, and many devices and systems have already been proposed in this technological context.

However, in the context of applications requiring a working precision of about a pm and a mean power density delivered to the working area of about 10¹² W/m² in pulsed mode (peak power density of about 10¹⁶ W/m²), there is an unmet demand for a simple, cost-effective and adaptive solution in terms of conveying the beam onto the working area.

One means known by those skilled in the art to transport a laser beam to a working area is an optical fiber, which may be provided at its free end with means for focusing the projected laser beam.

Thus, document EP 2,056,144 for example teaches an optical fiber and element in the form of an attached end piece, made from a material identical to that of the core of the fiber and intended to focus the beam. Nevertheless, the mounting of the end piece must be extremely precise, which makes it complex and delicate to produce. Furthermore, it results in stiffening of the end of the fiber, limiting its possibilities for orientation of the emitted beam. The ability to hold up under substantial laser flows is not ensured.

Known from the documents “Photonic nanojet focusing for hollow-core photonic crystal fiber probes”, Petru Ghenuche et al., Applied Optics, Vol. 51, No. 36, Dec. 20, 2012, Optical Society of America, and “Optical-fiber-microsphere for remote fluorescence correlation spectroscopy”, Heykel Aouani et al., OPTICS EXPRESS, Vol. 17, No. 21, Oct. 12, 2009, OSA, is also the implementation of hollow or partially hollowed optical fibers, on the free ends of which microspheres are attached intended to focus the emitted light flow. However, like before, this assembly is delicate and results in a transmission interface between the core of the fiber and the microsphere, the properties of which cannot always be determined precisely, and which necessarily generates losses. Furthermore, the type of fibers used in these two documents does not allow the application of high powers.

Lastly, document JP 63-98977 discloses, in the field of optical communications, the implementation of optical fibers including a hemispherical end obtained by simple melting of the material of the end of these fibers. The aim of this particular conformation of the end of the fibers is solely to limit the return of reflected light, and there is no mention of any focusing of the beam or power application.

The primary aim of the invention consists of providing a functional laser treatment device with a laser head having a simple structure that is easy to manufacture, withstanding high powers and able to provide a micrometric working beam, said device further having to be able to use this laser head optimally, and advantageously to allow a focusing of the emitted beam beyond the diffraction limit.

To that end, the invention relates to a laser treatment device comprising, on the one hand, a laser head essentially made up of an injection module able and intended to be powered by a laser source and by an optical fiber formed by a core surrounded by at least one sheath, connected to said injection module and ending with a beam focusing end piece, and, on the other hand, a support system for a part, an item or a material including at least one area to be treated by the laser head, or working area, the focusing end piece and the part, the item or the material being able to be positioned and moved relative to one another in a controlled manner, the device being characterized in that the focusing end piece is formed in a single piece with the optical fiber, of the type with a solid core, as the shaped part of the free end portion of the latter, opposite its end connected to the injection module, in that the focusing end piece has an axial symmetry of revolution and, seen in section along a plane containing the median axis or the axis of symmetry of the free end portion of the optical fiber, a shape outwardly delimited by a substantially semi-elliptical convex curve with a first-half-axis a, extending perpendicular to the median axis, which is such that a=D_{c}/2, and a second half-axis b, aligned with the median axis, which is such that D_{c}/4≤b≤D_{c}/3, with 1,000 λ≥D_{c}≥40 λ, where D_{c} is the diameter of the core of the optical fiber and λ is the wavelength of the injected laser radiation, and in that the distance d between the tip of the focusing end piece and the working area is such that 5D_{c}≥d≥50 λ, the geometry and the positioning of the end piece being such that the laser head generates a focused and slightly divergent laser beam in the form of a photon jet, with a diameter at the working area of the order of magnitude of the wavelength λ.

The invention also relates to a workstation and a treatment method implemented in this device.

The invention will be better understood owing to the following description, which relates to preferred embodiments, provided as non-limiting examples, and explained in reference to the appended schematic drawings, in which:

FIG. 1 is a symbolic illustration of a laser treatment device according to the invention mounted in a workstation according to the invention;

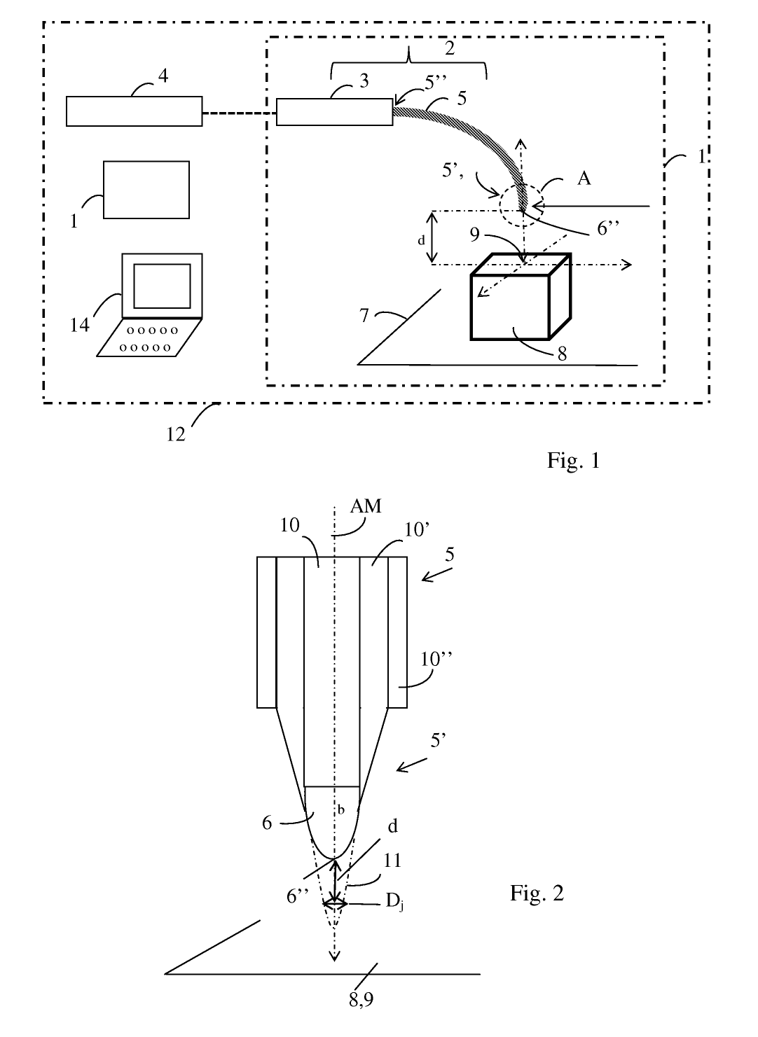

FIG. 2 is a partial schematic illustration on a different scale of the free end of the optical fiber belonging to the device shown in FIG. 1 (detail A of this figure);

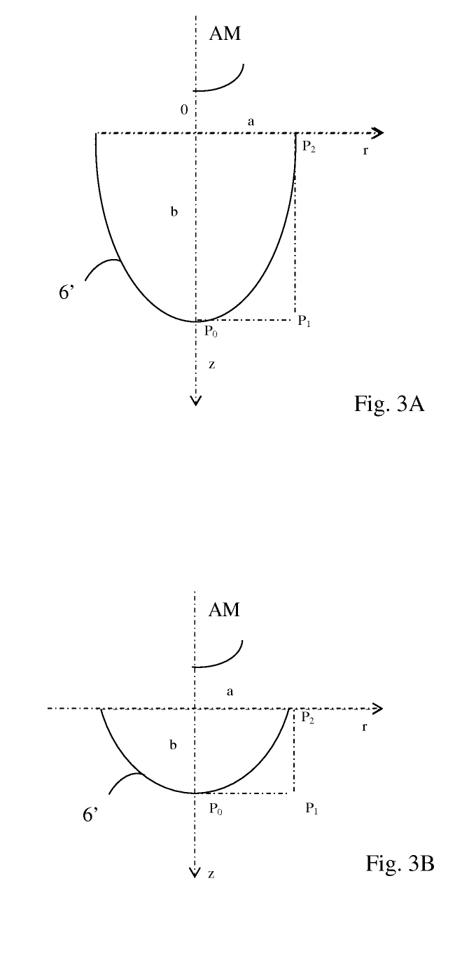

FIGS. 3A and 3B are graphic illustrations of two example curves that can define the outer shape of the focusing end piece of the fiber partially shown in FIG. 2;

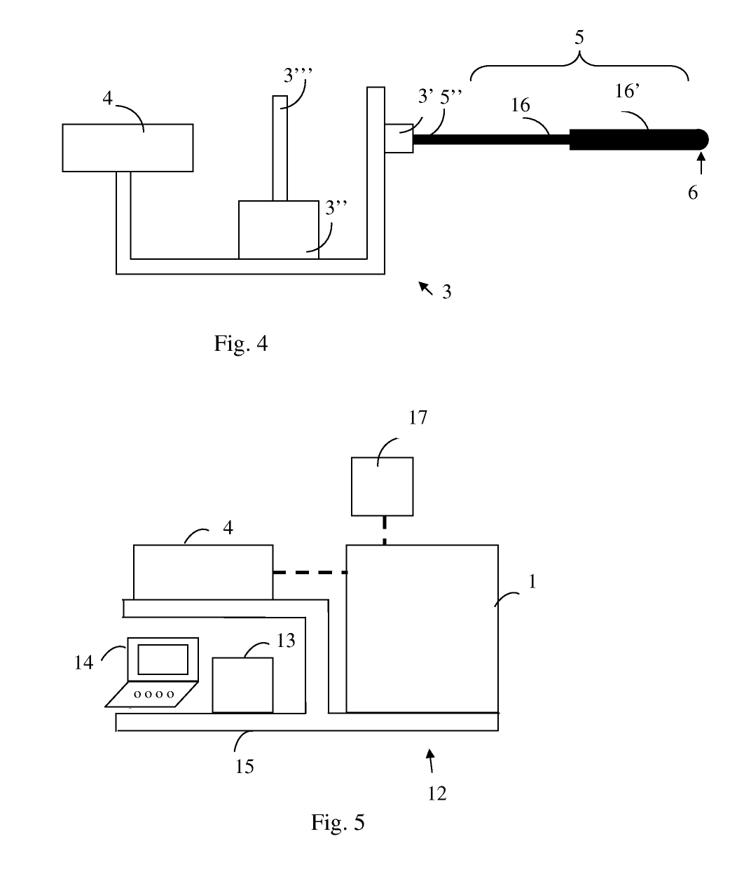

FIG. 4 is a schematic detail illustration showing an optical coupling device between the laser source and the optical fiber, belonging to the device shown in FIG. 1, and

FIG. 5 is a schematic illustration of one possible constructive configuration of the main component elements of the device shown in FIG. 1.

FIGS. 1, 4 and 5 illustrate a laser treatment device comprising, on the one hand, a laser head 2 essentially made up of an injection module 3 able and intended to be powered by a laser source 4 and by an optical fiber 5 formed from a core 10 surrounded by at least one sheath 10′, 10″, connected to said injection module and ending with a focusing end piece 6 of the beam, and on the other hand, a support system 7 for a part, item or material 8 including at least one area 9 to be treated by the laser head 2, or working area, the focusing end piece 6 and the part, item or material 8 being able to be positioned and moved relative to one another in a controlled manner.

According to the invention, and as shown more specifically in FIG. 2 in combination with FIG. 1, this device is characterized in that the focusing end piece 6 is formed in a single piece with the optical fiber 5, of the type with a solid core, as the shaped part of the free end portion 5′ of the latter, opposite its end connected to the injection module 3. Furthermore, the focusing end piece 6 has an axial symmetry of revolution and, seen in section along a plane containing the median axis or axis of symmetry AM of the free end portion 5′ of the optical fiber 5, a shape outwardly delimited by a substantially semi-elliptical convex curve 6′ with a first half-axis a, extending perpendicular to the median axis, which is such that a=D_{c}/2, and a second half-axis b, aligned with the median axis AM, which is such that D_{c}/4≤b≤2D_{c}/3, with 1,000 λ≥D≥40 λ, where D_{c} is the diameter of the core 10 of the optical fiber 5 and λ is the wavelength of the injected laser radiation.

Preferably, b≠D_{c}/2, therefore b≠a.

Lastly, the distance d between the tip 6″ of the focusing end piece 6 and the working area 9 is such that 5D_{c}≥d≥50 λ, the geometry and the positioning of the end piece 6 being such that the laser head 2 generates a focused and slightly divergent laser beam 11 in the form of a photon jet, with a diameter Dⱼ at the working area 9 of the order of magnitude of the wavelength λ.

The particular combination of the aforementioned technical arrangements, at once relative to the nature, the conformation, the dimensioning and the positioning relative to the working area 9 of the focusing end piece 6, allows the invention to achieve the desired aim.

In particular, these various specific arrangements make it possible to generate, directly at the fiber output 5, a photon jet 11 with a high mean power density (typically greater than 10¹² W/m²), on a very small surface area (typically a spot with a diameter Dj of about a pμm) and a sufficient distance d (typically between 50 and 500 μm, depending on the nature of the material) preventing dirtying of the end piece 6 by any projections of pulled out material or sublimation gas deposits.

Furthermore, the use of a fiber 5 with a large (typically with a transverse dimension Dc of about several tens to several hundreds of μm) and solid core 10 allows not only the transport of a high-power light flow, but also the focusing of this flow to generate a photon jet 11 at a distance and a limitation of the embrittlement of the free end 5′ of the fiber 5, resulting from the re-melting and the structural shaping of the end of the core 10 resulting in the focusing end piece 6.

According to one feature of the invention, allowing reliable reproducibility of one of the essential parameters of the invention, it is advantageously provided that the outer shape of the focusing end piece 6, which has a symmetry of revolution around the half-axis b, i.e., described parametrically by a rational Bezier curve Z(R) such that:

$$[ \begin{matrix}R ( t ) \\ Z ( t )\end{matrix} ] = \frac{{( 1 - t )}^{2} {P}_{0} + 2 {w}_{0} ( 1 - t ) {tP}_{1} + {t}^{2} {P}_{2}}{{( 1 - t )}^{2} + 2 {w}_{0} ( 1 - t ) t + {t}^{2}} ,$$

where t varies from 0 to 1, where the weight of the Bezier curve w₀ is such that 0.4≤w₀≤0.75, advantageously 0.4≤w₀≤0.5, preferably w₀=0.45, and where the control points P₀, P₁ and P₂ are:

$${P}_{0} = [ \begin{matrix}0 \\ b\end{matrix} ] , {P}_{1} = [ \begin{matrix}a \\ b\end{matrix} ] and {P}_{2} = [ \begin{matrix}a \\ 0\end{matrix} ] .$$

Advantageous practical alternative embodiments of the invention resulting in high performance levels related to the desired aim mention, according to the results obtained by the inventors, one or several of the following additional selective limitations:
500 λ≥D_{c}≥40 λ, preferably 100 λ≥D_{c}≥40 λ,
D_{c}/4≤b≤D_{c}/2, preferably D_{c}/4≤b≤D_{c}/2 (FIG. 3B).

When the latter limitations are also verified, a working distance d can be ensured such that d>Dc, which guarantees the preservation of the integrity of the end piece 6 during the laser treatment method, makes the slaving of the distance between the end piece 6 and the working area 9 less critical, and also allows a lateral resolution I of about λ owing to the photon jet generated at the end piece output 6.

According to another alternative embodiment, shown by FIG. 3A, b is such that D_{c}/2<b≤2D_{c}/3.

This alternative makes it possible to obtain a higher resolution than with the previous alternative (lateral resolution 1<λ). This second alternative is interesting when the laser treatment method is applied to a given material that does not risk harming the integrity of the end piece 6 even though the working distance d is such that d<Dc (example: micro-etching a silicon wafer).

Additionally and relative to a selective choice of the type of fibers 5 that may have advantageous technical characteristics for favorable use in the context of the invention, it may be provided that:

the fiber 5 is of the monomode or multimode type, preferably with a limited number of modes, or multimode with a small number of excited modes, and advantageously with a small numerical aperture, preferably a fiber with a double optical sheath 10′, surrounded by a mechanical sheath 10″, or a fiber with a semitransparent mechanical sheath (not shown),

the fiber 5 has a cylindrical shape, preferably with a circular section, and/or

the fiber 5 has a flexible structure allowing bending with a minimal curve radius up to at least 20 mm, preferably up to 10 mm.

In agreement with another alternative embodiment, it may be provided that the optical fiber 5 has an optical index gradient between the core 10 and the sheath 10′ surrounding the latter, the index varying from a high value at the center of the fiber 5, for example between 1.3 and 3.5, to a low value at the sheath 10′, for example between 1.2 and 3. This index gradient is preferably of the parabolic type and can be obtained by prior doping of the fiber 5 (technique known to manufacture gradient index fibers or gradient index lenses-GRIN), or during shaping of the end piece 6 by thermoforming.

According to another alternative embodiment, shown by FIG. 4, the optical fiber 5 may have, in the direction of its longitudinal axis AM, a composite structure comprising, on the one hand, a first portion 16 (including the input or injection end 5″) that is made up of a fiber with relatively few modes, but having a large diameter, preferably monomode with a small numerical aperture, for example of the optical fiber type with a large mode diameter or LMA (Large Mode Area) fiber, and on the other hand, a second portion 16′ that is welded to the first portion 16, has a larger core diameter and includes, at its free end, the focusing end piece 6 shaped in a single piece and able to generate the photon jet 11.

Owing to these arrangements, the first portion 16 makes it possible to excite only the low-order modes of the second portion 16′, and thus to better favor the phenomenon of the photon jet 11 at the output, which makes it possible to concentrate the beam beyond the diffraction limit. Furthermore, the injection in the first portion 16 is made easier (core with a large diameter).

Non-limitingly, the optical fiber 5, or at least the first portion 16, has a small numerical aperture NA (for example 0.05≤NA≤0.25), and for a wavelength of 1 μm may for example be of the type:

LMA monomode fiber of with a core of 20 microns and a numerical aperture of 0.08;

monomode LMA fiber with a core diameter of 50 μm, a sheath in a concentric ring forming a Bragg structure and a numerical aperture of about 0.12;

high-power multimode step index fiber: silica core/silica optical sheath/polymer coating: respective dimensions in μm 50/125/250; germanium-doped core; numerical aperture of 0.12.

Non-limitingly, the second fiber portion 16′, welded with butting to the first portion 16, can for example be of the type:

silica step index fiber, with a core having a diameter of 50 μm or 100 μm and a numerical aperture of 0.22;

high-power step index fiber: silica core/silica optical sheath 1/TEQS optical sheath 2/polymer coating: respective dimensions in μm 200/240/260/400; germanium-doped core; numerical aperture of 0.22.

In all of the implementation scenarios of the invention, one seeks to use a fiber 5 or a first portion 16 with a large core diameter (advantageously greater than 10 μm, preferably at least 20 μm) and few modes, preferably substantially monomode, as well as a small numerical aperture (for example, smaller than 0.20).

In this context, a fiber of the LMA type is favored.

Thus, the laser treatment device 1 according to the invention as defined above makes it possible, in connection with a power laser source 4 (i.e., with a working power P greater than or equal to 100 MW in continuous or pulsed mode, preferably at least about 1 W) and a solid fiber 5 (in a single piece or formed by two portions 16, 16′ connected by welding) able to transmit such a power, to perform a treatment of a material, in particular a surface treatment (surface etching, surface melting of a material, surface oxidation, marking, surface crystallization, photo-polymerization, thin layer piercing, etc.), with a high lateral resolution comprised between λ2 and 5 λ.

Furthermore, by implementing an optical fiber 5 that is flexible and equipped with an integrated (formed in the mass of the core 10) and small focusing end piece 6, the resulting laser head 2 is extremely compact at its free operational end and shows great invasive potential making it possible to reach and treat hard-to-access zones: action on tissues or organs in an endoscopic application, machining of the inside of a metal tube, surface treatment at an undercut, or the like.

In order to facilitate the maintenance of the device 1 and optimize coupling [injection module 3/fiber 5], the injection module 3 advantageously comprises (see FIG. 4) a quick coupling means 3′ for the input end 5″ of the optical fiber 5, ensuring protection of the input section of the latter, and a three-dimensional micro-positioning means 3″, able and intended to arrange said input section at the focal point of the focusing lens of said module 3. The quick coupling means 3′ is preferably a high-power optical fiber connector able to be cooled. The micro-positioning means 3″ may for example bear a focusing lens 3″ for which it ensures precise positioning relative to the input end 5″ to achieve optimized optical coupling.

The injection module 3 is advantageously configured to be able to be fastened at the output of a power laser or a power laser diode, or to be able to replace the optical head of an existing etching system (for example by replacing a galvanometric head).

Owing to the aforementioned provisions, the invention makes it possible to generate a photon jet by focusing the radiation beyond the diffraction limit.

The control of the injection of the radiation and the favored use of the light from the low-order modes can in particular favor this phenomenon.

By varying and adapting some of the previously indicated dimensional parameters, while keeping the essential structural and constructive characteristics previously mentioned, the invention can also be implemented for applications other than those mentioned in the introduction, still by optimally exploiting the proposed specific laser head.

Thus, for applications seeking to etch with resolutions lower than those mentioned above, for example between 5 λ and 10 λ, the ability to focus the beam by photon jet at the optical fiber end piece on a diameter 5 λ≤D≤10 λ makes it possible to work with less powerful, and therefore cost-effectively and ecologically more interesting, sources. This meets a need that the current technical solutions do not resolve at this time. For these applications, end pieces 6 and constructive configurations of the device 1 may be considered with:
5D_{c}≤d≤10D_{c} (distance: end piece/working area) and
0.75≤w_{0≤}2 (weight of the Bezier curve).

Example 4 below illustrates a practical, non-limiting embodiment corresponding to this breakdown of the invention.

The invention also relates, as shown schematically and symbolically in FIG. 1, and partially in FIG. 5, to a workstation 12 for machining parts, items or materials 8, in particular for surface treatment, etching, cutting, piercing or marking.

This workstation 12 comprises a power laser source 4, with pulsed or continuous emission, a control unit 13, connected to sensors (not shown), actuators (in particular for the relative movement between the head 2 and support 7), the laser source 4 and optionally a control and/or programming interface 14, a laser treatment device 1 coupled to the laser source 4 and controlled by the control unit 13, and a structure or support frame 15.

This workstation 12 is characterized in that the laser treatment device 1 corresponds to a device as previously described, the relative positioning and movement between the focusing end piece 6 shaped on the end portion 5′ of the optical fiber 5 and the part, item or material 8 to be treated being controlled by the control unit 13 using corresponding sensors and actuators (not shown—known as such by those skilled in the art) equipping the laser head 2 and/or the support system 7.

Preferably, the relative movement, continuous or intermittent, between the part, item or material 8 on the one hand, and the laser head 2 or the optical fiber 5 on the other hand, is controlled by the control unit 13 by implementing slaving guaranteeing control of the distance d between the focusing end piece 6 and the working area 9, either by keeping an initially adjusted value, or by making one or more adjustments to this distance, during such a relative movement, corresponding to an effective treatment cycle or phase.

The station 12 may also comprise a communication, display and programming interface 14, allowing an operator to configure, command and control the operation of said station, in particular as a function of the part, item or material 8 to be treated and the treatment to be done.

Advantageously, the laser source 4 is an effective power laser source, with a working power greater than 100 mW, preferably at least about a Watt or around 10 Watts.

According to an additional feature of the invention, shown schematically in FIG. 5, the workstation 12 can comprise, on the one hand, a sensor 17 for measuring the light retroreflected by the working area 9 in the optical fiber 5 through the end piece 6, and on the other hand, a coupler (not shown) mounted at the input end 5″ of the optical fiber 5 and able to recover and send, to said sensor 17, the retroreflected light having passed through said fiber 5 from the end piece 6, these measured values being exploited, preferably in real time, by the control unit 13 to slave the distance d between the end piece 6 and the working area 9.

According to another alternative embodiment, the workstation 12 may comprise a measuring sensor 17 in the form of a camera with a macro lens that observes the region of the end piece 6 and of the working area 9, lit by one or several dedicated light sources (not shown), the images provided by said camera 17 being exploited, preferably in real time, by the control unit 13 to slave the distance d between the end piece 6 and the working area 9.

One of the dedicated light sources may optionally correspond to a laser pointer associated with the power laser source 4 and lighting the working area 9.

Lastly, the invention also relates to a method for treating an item, a part or a material 8 implemented in a laser treatment device 1 as previously described, preferably belonging to a workstation 12 as mentioned above.

This method is characterized in that it consists, prior to an actual treatment cycle or phase, of fastening an optical fiber 5 having a focusing end piece 6, shaped in a single piece and able and intended to produce a photon jet 11, on the part, item or material 8 in the working area 9, to adjust the relative positioning of the input section of the fiber 5 in order to optimize the injection (of the laser beam from the source 4), optionally to conform the fiber 5 as a function of the shape of the part, item or material 8 to be treated, the location of the working area 9, the path to be traveled to perform the treatment cycle or similar geometric and/or topographical considerations, in particular to adjust the power of the laser source 4, the optimal distance d between the end piece 6 and the part, item or material 8 and the relative movement speed, as a function at least of the nature of said part, said item or said material 8 or its surface, and lastly, to begin the treatment under the control of the control unit 13, preferably following a preprogrammed journey or treatment cycle.

The modeling method by melting the end piece 6 of the optical fiber 5 may for example be similar to that implemented to produce probes in SNOM (near field optical microscopy) and proposed by the companies Lovalite and Laseoptics.

Different practical example embodiments of the invention will now be described as illustrations of non-limiting alternative embodiments.

### EXAMPLE 1

A workstation 12 is made with a nanosecond pulsed laser 4 in the near infrared having a working power P≈20 W, λ≈1 μm, a pulse duration of 150 ns and a repetition frequency of 5 kHz, and a silica fiber 5, with an optical double sheath, with a core diameter D_{c}=200 μm. The fiber 5 includes a shaped end piece 6 with a half-axis b=100 μm and a weight of the Bezier curve w₀=0.45. The working area 9 is situated at a distanced of 150 μm from the end piece and the etching resolution is 1≈3 μm.

With such a workstation 12, it is possible to etch a glass surface, despite its low absorption in the spectral domain.

### EXAMPLE 2 (TWO ALTERNATIVES)

A workstation 12 is produced with a nanosecond pulsed laser in the near infrared having a working power P≈5 W and λ≈1 μm (for example Nd: YAG or Ytterbium-doped fiber), a pulse duration of 20 ns and a repetition frequency of 20 kHz and with a silica fiber 5:

either with core diameter D_{c}=100 μm: in this case, it may be possible to take an end piece length b=33 μm and a weight of the Bezier curve w₀=0.45. The working area will then be at a distance d of 90 μm from the end piece and the etching resolution will be 1≈2 μm;

or with core diameter D_{c}=50 μm: in this case, it may be possible to take an end piece length b=13 μm and a weight of the Bezier curve w₀=0.45. The working area will then be at a distance d of 60 μm from the end piece and the etching resolution will be 1≈2 μm.

In these two cases as well, glass may be etched on the surface.

### EXAMPLE 3

A workstation 12 is produced with a nanosecond pulsed laser in the ultraviolet having a working power P≈20 W and λ≈248 nm (for example, KrF excimer Laser) and with a silica fiber 5 having a core diameter D_{c}=50 μm. In this case, it may be possible to take an end piece length b=38 μm and a weight of the Bezier curve w₀=0.45. The working area 9 will then be at a distance d of 38 μm from the end piece and the etching resolution will be 1≈0.5 μm.

### EXAMPLE 4

A workstation 12 is produced with a pulsed or continuous laser diode 4 in the near infrared having a working power P≈100 MW, λ≈1 μm. A silica fiber 5 is used, with a core diameter D_{c}=400 μm and an end piece 6 with length b=150 μm. The outer shape of the end piece 6 is described by a rational Bezier curve with a weight w₀=1.7. The working area 9 is situated at a distance d of 800 μm from the end piece and the etching resolution is 1≈5-10 μm.

The characteristic data of the five alternatives (Examples 1 to 4) described above, as well as those of the two additional alternatives (not specifically described), are summarized in the following table:

| | | Pulse | λ | Dc | | | d | |
|---|---|---|---|---|---|---|---|---|
| Fiber | P (W) | duration | (nm) | (μm) | b (μm) | W | (μm) | l (μm) |
| Si02 | 20 | 20 ns | 1060 | 200 | 100 | 0.45 | 150 | 3 |
| SiO2 | 5 | 20 ns | 1060 | 100 | 33 | 0.45 | 90 | 2 |
| SiO2 | 5 | 20 ns | 1060 | 50 | 13 | 0.45 | 60 | 2 |
| SiO2 | 20 | 20 ns | 248 | 50 | 38 | 0.45 | 38 | 0.5 |
| SiO2 | 5 | 20 ns | 248 | 25 | 17 | 0.45 | 23 | 0.5 |
| SiO2 | 1 | Infinite | 514 | 50 | 17 | 0.45 | 45 | 1 |
| SiO2 | 0.1 | Infinite | 1060 | 400 | 150 | 1.7 | 800 | 5-10 |

Of course, the invention is not limited to the embodiments described and shown in the appended drawings. Modifications remain possible, in particular in terms of the composition of the various elements or by equivalent technical substitution, without going beyond the scope of protection of the invention.

1. A laser treatment device
comprising both a laser head essentially made up of an injection module able and intended to be powered by a laser source and by an optical fiber formed by a core surrounded by at least one sheath, connected to said injection module and ending with a beam focusing end piece, as well as a support system for a part, an item or a material including at least one area to be treated by the laser head, or working area,
the focusing end piece and the part, the item or the material being able to be positioned and moved relative to one another in a controlled manner, wherein
the focusing end piece (6) is formed in a single piece with the optical fiber (5), of the type with a solid core, as the shaped part of the free end portion (5′) of the latter, opposite its end connected to the injection module (3), wherein in that the focusing end piece (6) has an axial symmetry of revolution and, seen in section along a plane containing the median axis or axis of symmetry (AM) of the free end portion (5′) of the optical fiber (5), a shape outwardly delimited by a substantially semi-elliptical convex curve (6′) with a first-half-axis a, extending perpendicular to the median axis (AM), which is such that a=D_{c}/2, and a second half-axis b, aligned with the median axis, which is such that D_{c}/4≤b≤2D_{c}/3, with 1,000 λ≥D≥40 λ, where D_{c} is the diameter of the core (10) of the optical fiber (5) and λ is the wavelength of the injected laser radiation,
and wherein the distance d between the tip (6″) of the focusing end piece (6) and the working area (9) is such that 5D_{c}≥d≥50 λ, the geometry and the positioning of the end piece (6) being such that the laser head (2) generates a focused and slightly divergent laser beam (11) in the form of a photon jet, with a diameter Dⱼ at the working area (9) of the order of magnitude of the wavelength λ.

2. The laser treatment device according to claim 1, wherein the outer shape of the focusing end piece (6) is described parametrically by a rational Bezier curve Z(R) such that:
$$[ \begin{matrix}R ( t ) \\ Z ( t )\end{matrix} ] = \frac{{( 1 - t )}^{2} {P}_{0} + 2 {w}_{0} ( 1 - t ) {tP}_{1} + {t}^{2} {P}_{2}}{{( 1 - t )}^{2} + 2 {w}_{0} ( 1 - t ) t + {t}^{2 }} ,$$
where t varies from 0 to 1, where the weight of the Bezier curve w₀ is such that 0.4≤w₀≤0.75, advantageously 0.4≤w₀≤0.5, preferably w₀=0.45, and where the control points P₀, P₁ and P₂ are:
$${P}_{0} = [ \begin{matrix}0 \\ b\end{matrix} ] , {P}_{1} = [ \begin{matrix}a \\ b\end{matrix} ] and {P}_{2} = [ \begin{matrix}a \\ 0\end{matrix} ] .$$

3. The laser treatment device according to claim 1, wherein the optical fiber (5) is of the multimode type, surrounded by a mechanical sheath (10″), or a fiber with a semitransparent mechanical sheath.

4. The laser treatment device according to claim 1, wherein the fiber (5) has a cylindrical shape.

5. The laser treatment device according to claim 1, wherein 100 λ≥D_{c≥}40 λ, and λ2≥Dⱼ≥5 λ.

6. The laser treatment device according to claim 1, wherein the second half-axis (b) is such that D_{c}/4≤b≤2D_{c}/3 and b≠D_{c}/2.

7. The laser treatment device according to claim 1, wherein the second half-axis (b) is such that D_{c}/4≤b≤D_{c}/2.

8. The laser treatment device according to claim 1, wherein the second half-axis (b) is such that D_{c}/4≤b≤D_{c}/2.

9. The laser treatment device according to claim 1, wherein the second half-axis (b) is such that D_{c}/2≤b≤2D_{c}/3.

10. The laser treatment device according to claim 1, wherein the optical fiber (5) has an optical gradient index between the core (10 and the sheath (10′) surrounding the latter, the index varying from a high value at the center of the fiber (5) to a lower value at the sheath (10′).

11. The laser treatment device according to claim 1, wherein the optical fiber (5) has, in the direction of its longitudinal axis (AM), a composite structure comprising a first portion (16) that is made up of a fiber with relatively few modes, preferably monomode, a large diameter, and a small numerical aperture, for example of the optical fiber type with a large mode diameter or LMA fiber, and a second portion (16′) that is welded to the first portion (16), has a larger core diameter and includes, at its free end, the focusing end piece (6) shaped in a single piece and able to generate the photon jet (11).

12. The laser treatment device according to claim 1, wherein the injection module (3) comprises a quick coupling means (3′) for the input end (5″) of the optical fiber (5), ensuring protection of the input section of the latter, and a three-dimensional micro-positioning means (3″), able and intended to arrange said input section at the focal point of the focusing lens (3′″) of said module (3).

13. A workstation for machining parts, items or materials, in particular for surface treatment, etching, cutting, piercing or marking, comprising a power laser source, with pulsed or continuous emission, a control unit, connected to sensors, actuators, the laser source and optionally a control and/or programming interface, a laser treatment device coupled to the laser source and controlled by the control unit, and a structure or support frame, wherein
the laser treatment device (1) corresponds to a device according to claim 1, the relative positioning and movement between the focusing end piece (6) shaped on the end portion (5′) of the optical fiber (5) and the part, item or material (8) to be treated being controlled by the control unit (13) using corresponding sensors and actuators equipping the laser head (2) and/or the support system (7).

14. The workstation according to claim 13, wherein the relative movement, continuous or intermittent, between the part, item or material (8) and the laser head (2) or the optical fiber (5), is controlled by the control unit (13) by implementing slaving guaranteeing control of the distance d between the focusing end piece (6) and the working area 9, either by keeping an initially adjusted value, or by making one or more adjustments to this distance, during such a relative movement, corresponding to an effective treatment cycle or phase.

15. The workstation according to claim 13, wherein the laser source (4) is a power laser source, with a working power greater than 100 mW, preferably at least around a Watt or around ten Watts.

16. The workstation according to claim 13, characterized in that it comprises a sensor (17) for measuring the light retroreflected by the working area (9) in the optical fiber (5) through the end piece (6) and a coupler mounted at the input end (5″) of the optical fiber (5) and able to recover, and send to said sensor (17), the retroreflected light having passed through said fiber (5) from the end piece (6), these measured values being used, preferably in real time, by the control unit (13) to slave the distance (d) between the end piece (6) and the working area (9).

17. The workstation according to claim 13, further comprising a measuring sensor (17) in the form of a camera with a macro lens that observes the region of the end piece (6) and of the working area (9), lit by one or several dedicated light sources, the images provided by said camera (17) being exploited, preferably in real time, by the control unit (13) to slave the distance (d) between the end piece (6) and the working area (9).

18. A method for treating an item, a part or a material implemented in a laser treatment device according to claim 1,
the method further comprising fastening an optical fiber (5) having a focusing end piece (6), shaped in a single piece and able and intended to produce a photon jet (11), on the part, item or material (8) in the working area (9), to adjust the relative positioning of the input section of the fiber (5) in order to optimize the injection, optionally to conform the fiber (5) as a function of the shape of the part, item or material (8) to be treated, the location of the working area (9), the path to be traveled to perform the treatment cycle or similar geometric and/or topographical considerations, in particular to adjust the power of the laser source (4), the optimal distance d between the end piece (6) and the part, item or material (8) and the relative movement speed, as a function at least of the nature of said part, said item or said material (8) or its surface, and lastly, to begin the treatment under the control of the control unit (13), preferably following a preprogrammed journey or treatment cycle.

19. The laser treatment device according to claim 3, wherein the optical fiber (5) comprises a double optical sheath.

20. The laser treatment device according to claim 4, wherein the fiber (5) has a circular section and a flexible structure allowing bending with a minimal curve radius up to at least 20 mm.
